(19) United States
(12) Patent Application Publication
(10) Pub. No.: US 2025/0170483 A1
(43) Pub. Date: May 29, 2025

(54) DISPLAY METHOD FOR SKILL INDICATOR, AND ELECTRONIC DEVICE, AND STORAGE MEDIUM THEREOF

(71) Applicant: NETEASE (HANGZHOU) NETWORK CO., LTD., Hangzhou, Zhejiang (CN)

(72) Inventor: Rui LIU, Hangzhou, Zhejiang (CN)

(73) Assignee: NETEASE (HANGZHOU) NETWORK CO., LTD., Hangzhou, Zhejiang (CN)

(21) Appl. No.: 18/841,691

(22) PCT Filed: Feb. 10, 2023
(86) PCT No.: PCT/CN2023/075502

§ 371 Date: Aug. 27, 2024

(30) Foreign Application Priority Data
Mar. 2, 2022 (CN) 202210197638.3

(51) Int. Cl. A63F 13/5372; G06F 3/0486

(52) U.S. Cl. CPC A63F 13/5372; G06F 3/0486; A63F 2300/308

(57) ABSTRACT

A display method for a skill indicator includes: in response to a trigger operation on a target skill, determining a release position and an effect range of the target skill, the release position being one scene unit in a virtual scene, the release position being located in the effect range, and the effect range including a plurality of scene units; based on relative positions of a plurality of specified scene units in the effect range, determining direction information of a skill indicator of the target skill; and based on an indicator parameter that is preset for the target skill, and using the release position as a reference, generating and displaying the skill indicator in the direction indicated by the direction information.

### CROSS REFERENCE TO RELATED APPLICATIONS

The present disclosure is a U.S. national phase application of International Application No. PCT/CN2023/075502, filed on Feb. 10, 2023, which is based upon and claims priority to Chinese Patent Application No. 202210197638.3, filed on Mar. 2, 2022 and entitled “DISPLAY METHOD AND APPARATUS FOR SKILL INDICATOR, ELECTRONIC DEVICE, AND STORAGE MEDIUM”, the entire contents of both of which are incorporated herein by reference for all purposes.

### TECHNICAL FIELD

The present disclosure relates to the field of human-machine interaction, in particular, to a method for a skill indicator, an apparatus for a skill indicator, an electronic device, and a storage medium.

### BACKGROUND

In combat games, the map in a game scene is usually composed of continuous polygons, such as quadrilaterals or hexagons. The hexagonal scene map has many advantages compared to the quadrilateral scene map. For example, the hexagon has a larger area that the quadrilateral having the same perimeter, distances from a center of a hexagon to centers of adjacent hexagons in all directions are equal, and the strategy in the hexagonal scene is deeper. In addition, for AOE (Area of Effect) skills, a skill indicator is usually displayed before the skill is released, which indicates an effect area after the skill is released based on a release direction and an effect range of the skill.

It should be noted that the information disclosed in the above section is used to enhance the understanding of the background of the present disclosure only, and thus can include information that does not constitute prior art already known to those of ordinary skill in the art.

### SUMMARY

A first aspect of the present disclosure provides a display method for a skill indicator. The method provides a graphical user interface through a terminal device, a virtual scene is displayed in the graphical user interface, and the virtual scene is composed of multiple scene units arranged continuously. The scene unit is a hexagon. The method includes: determining, in response to a triggering operation on a target skill, a release position and an effect range of the target skill, wherein the release position is a scene unit in the virtual scene, the release position is located in the effect range, and the effect range includes multiple scene units; determining direction information of the skill indicator of the target skill based on relative positions of multiple specified scene units in the effect range; and generating and displaying the skill indicator along a direction indicated by the direction information, based on an indicator parameter preset for the target skill, by taking the release position as a reference.

A second aspect of the present disclosure provides an electronic device including a processor and a memory, wherein the memory stores machine-executable instructions that can be executed by a processor, and the processor is configured to execute the machine-executable instructions to implement the display method for the skill indicator as described above.

A third aspect of the present disclosure provides a non-transitory computer-readable storage medium having computer-executable instructions stored thereon. When the computer-executable instructions are called and executed by a processor, cause the processor to implement the display method for the skill indicator as described above.

Other features and advantages of the present disclosure will be set forth in the subsequent specification, and will partially become apparent from the specification, or may be learned through the implementation of the present disclosure. The objectives and other advantages of the present disclosure will be achieved and obtained through the structures specifically indicated in the specification, claims, and drawings.

It should be understood that the general description in the above and the detailed description in the following are only exemplary and explanatory, and cannot limit the present disclosure.

In order to make the above objectives, features, and advantages of the present disclosure more obvious and understandable, preferred embodiments will be exemplified in the following, and detailed explanations will be provided with reference to the drawings.

### BRIEF DESCRIPTION OF THE DRAWINGS

In order to provide a clearer explanation of specific embodiments in the present disclosure or technical solutions in the prior art, the drawings required for the specific embodiments or description of the prior art will be briefly introduced in the following. It is apparent that the drawings in the following description are only some embodiments of the present disclosure, and for those of ordinary skill in the art, other drawings can also be obtained from these drawings without creative efforts.

FIG. 1 is a schematic diagram of a skill indicator indicating an effect range according to one or more embodiments of the present disclosure;

FIG. 2 is a flowchart of a display method for a skill indicator according to one or more embodiments of the present disclosure;

FIG. 3 is a schematic diagram of positioning a scene unit in a hexagonal coordinate system according to one or more embodiments of the present disclosure:

FIG. 4 is a schematic diagram of an effect range according to one or more embodiments of the present disclosure:

FIG. 5 is a schematic diagram of a position relationship according to one or more embodiments of the present disclosure:

FIG. 6 is a schematic diagram of a position relationship according to one or more embodiments of the present disclosure:

FIG. 7 is a schematic diagram of a skill indicator indicating an effect range according to one or more embodiments of the present disclosure;

FIG. 8 is a schematic diagram of data processing during a generation process of a skill indicator according to one or more embodiments of the present disclosure:

FIG. 9 is a schematic diagram of a structure of a display apparatus for a skill indicator according to one or more embodiments of the present disclosure; and

FIG. 10 is a schematic diagram of a structure of an electronic device according to one or more embodiments of the present disclosure.

### DETAILED DESCRIPTION

In order to make the purpose, technical solutions, and advantages of embodiments of the present disclosure clearer, a clear and complete description of the technical solutions in embodiments of the present disclosure will be provided in the following in conjunction with the drawings. It is apparent that the embodiments described are only a part of the embodiments of the present disclosure, not all of them. Based on the embodiments of the present disclosure, any other embodiments obtained by those skilled in the art without any creative efforts will fall within the protection scope of the present disclosure.

In most virtual scene applications, for example, in combat games, it is necessary to set up a scene map for users to control characters to move within the map. Compared to the quadrilateral map, the scene map spliced by hexagons are increasingly widely used due to their advantages of the larger area under the same perimeter, equal distances from a cell center to adjacent cell centers in all directions, and the deeper strategy. During the combat, the user can control the character to release AOE skills. In order to maximize the combat strategy in the hexagonal map scene, it is crucial to use the skill indicator to accurately and clearly display to the user the effect range or area of the skill before the skill effect occurs.

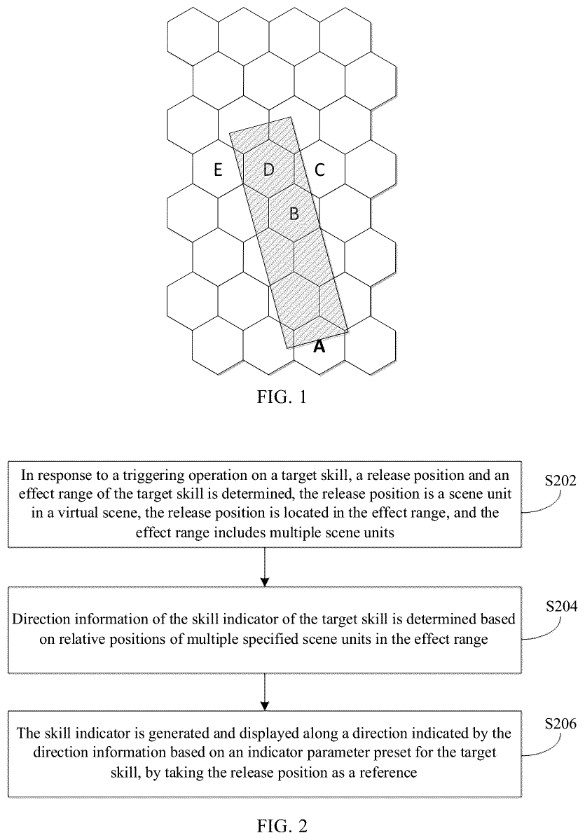

The skill indicator is a control that is generated based on a certain size and direction, and indicates a scene area covered by the effect range of the skill. The skill indicator has various shapes such as rectangles, circles, sectors, and cones. In the related art, the skill indicator is generated and displayed in a purely physical manner. FIG. 1 shows an example of a rectangular skill indicator indicating an effect area. A relevant coordinate system (such as a two-dimensional coordinate system) is established with a certain point on the map as a zero point in the hexagonal map scene, and the location of each geometric point contained inside the hexagon in the scene map is positioned as point coordinates. As shown in the drawings, point A represents the location of the target character, and the user locks parameters related to the skill that the character needs to release and releases the skill at location B in the map. Coordinates of an effect location are calculated in the coordinate system based on the skill parameters, and a skill indicator is generated and displayed using a direction vector obtained from coordinates of the effect location and the location A, and a pre-defined indicator size. The skill indicator is shown as a rectangle filled with diagonal lines in the drawings. However, when the effect area indicated by the skill indicator intersects with the hexagonal map at positions that are neither edges nor corners of the hexagon, which may easily confuse users about whether the effect will be caused at locations E and C. Therefore, the skill indicator generated and displayed based on the point in the map as a minimum calculation unit cannot take advantage of the deeper strategy brought by hexagonal grids. In addition, the skill indicator generated through the above method often intersects with the hexagon at neither edges nor corners of the hexagon, making it difficult to clearly identify whether an intersection part is affected. This would greatly confuse users in their understanding of the hexagon and in the use of the hexagon for strategy matching. Such skill indicators have poor indication effectiveness, which will affect the users' combat decisions.

Embodiments of the present disclosure provide a display method for a skill indicator, a display apparatus for a skill indicator, a computer-readable storage medium, and an electronic device. The present disclosure can be applied in games or other virtual scenes, especially in skill indication in combat games.

The display method for the skill indicator disclosed in embodiments of the present disclosure can be applied to a local touch terminal device or a server. When the display method for the skill indicator is applied to the server, the method can be implemented and performed based on a cloud interaction system. The cloud interaction system includes the server and client devices.

In some embodiments of the present disclosure, various cloud applications can run on the cloud interaction system, such as a cloud game, which will be taken as an example in the following. The cloud game refers to a gaming style based on cloud computing. In the running mode of the cloud game, a running body of the game program and a body for presenting the game screen are separated. The storage and running of the display method for the skill indicator are completed on the cloud game server. The client device is used to receive and send data, and to present the game screen. For example, the client device can be a display device close to the user's side, and has data transmission function. For example, the client device can be mobile terminals, televisions, computers, handheld computers, etc. The information processing is carried out by the cloud game server in the cloud. When playing the game, the player operates the client device to send operation instructions to the cloud game server. The cloud game server runs the game according to the operation instructions, encodes and compresses the game screen and other data, and returns them to the client device through the network. The game screen is finally decoded and output through the client device.

In some embodiments of the present disclosure, taking games as an example, the local touch terminal device stores the game program and is used to present the game screen. The local touch terminal device provides a graphical user interface to interact with the player, that is, generally, the local terminal device is used to download, install, and run the game program. The local terminal device can provide the graphical user interface to players in various ways, for example, rendering and displaying the graphical user interface on the terminal's display screen, or providing the graphical user interface to players through holographic projection. In some embodiments, the local touch terminal device can include a display screen and a processor. The display screen is used to present the graphical user interface that includes game screens. The processor is used to run the game, generate the graphical user interface, and control the display of the graphical user interface on the display screen.

Embodiments of the present disclosure provide a display method for a skill indicator, which provides a graphical user interface through a touch terminal device, and the touch terminal device can be the local touch terminal device or the client device in the cloud interaction system mentioned in the above. The touch terminal device provides a graphical user interface that can display an interface content, such as game scene screens, communication interaction windows, etc., based on the type of the application being launched. In some embodiments, a virtual scene is displayed in the graphical user interface, which can be a simulated environment of the real world, a semi simulated and semi fictional virtual environment, or a purely fictional virtual environment. It should be noted that the virtual scene is spliced by multiple scene units arranged in a continuous manner. In some embodiments, the shape of the scene unit is a hexagon. That is, the virtual scene is composed of continuously arranged hexagons, and six edges of each hexagon are adjacent to other hexagons, except for the hexagons located at the boundaries. For the convenience of understanding of the embodiments, the display method for the skill indicator disclosed in embodiments of the present disclosure will be introduced first in detail, as shown in FIG. 2. A graphical user interface is provided through a terminal device, and virtual scenes are displayed in the graphical user interface. The virtual scene is composed of multiple scene units arranged continuously, and the scene unit is a hexagon. The display method for the skill indicator includes the following steps S202 to S206. In some embodiments, in step S202, in response to a triggering operation on a target skill, a release position and an effect range of the target skill is determined. The release position is a scene unit in a virtual scene, the release position is located in the effect range, and the effect range includes multiple scene units.

The skill refers to various special functions that can assist a target character in interacting with other characters in the virtual scene. The skill can include different skill types, such as attack skills, defense skills, healing skills, etc. The skills can also be divided into direction based skills and range based skills. The direction based skills refer to skills that require specifying a release direction or a release target during the skill release process. The range based skills refer to skills that require specifying a release range during the skill release process. The release range can be determined by a specified shape and a release distance.

In some embodiments, the target skill is a range based ability of the target character controlled by the user, the target character using or releasing the target skill to have an effect on other virtual characters. The effect shapes of the skill include rectangles, circles, sectors, cones, etc., and the effect distance can be set in various ways. The user can control the target character to release the target skill to a hexagonal scene unit in the virtual scene, triggering a range based effect at the location of the hexagonal scene unit and causing a certain effect area in the scene. The location of the hexagonal scene unit is the release position, the effect range can be determined based on parameters such as the effect shape and the effect distance of the skill, and the effect range includes multiple scene units including the release position. For example, when the effect shape of the skill is a circle, the effect range can include the release position and multiple hexagonal scene units centered on the release position, and an outline of the multiple hexagonal scene units is approximate to the circle.

The triggering operation is a user operation received by the client that is exerted on the skill button by the user. The client generates the triggering instruction based on the user operation received. For example, the user operation can be at least one of operations on controls in the user interface, voice operations, action operations, text operations, mouse operations, keyboard operations, or game joystick operations.

In some embodiments, in step S202, in the graphical user interface or a specified window in the graphical user interface, the user triggers the skill control to control the target character to release the target skill. In response to the triggering operation by the user, the release location and the effect range of the target skill are determined. In some embodiments, the release location can be determined based on a position of the hexagonal scene unit where the skill release point is located. The effect range can be determined based on a collection of positions of the hexagonal scene units covered by the effect distance of the skill. According to some embodiments, the hexagonal scene unit is used as the minimum unit to position the release position and the effect range, so that the effect area is highly aligned with the virtual scene, improving the accuracy of the effect range.

In step S204, direction information of the skill indicator of the target skill is determined based on relative positions of multiple specified scene units in the effect range.

In some embodiments, the skill indicator has a certain size and a certain direction, and is used to indicate the effect range after the target skill is released. The shape of the indicator is generally the same as the effect shape of the skill, including the rectangular indicator, the circular indicator, the sectorial indicator, and the conical indicator. The effect range indicated by the skill indicator includes multiple hexagonal scene units, and the hexagonal scene unit is used as the minimum measurement unit. The direction information of the skill indicator is determined based on the relative positions of multiple specified scene units in the effect range. In some embodiments, a target scene unit that is located farthest from the release position in the effect range is obtained, and the direction information of the skill indicator of the target skill can be determined based on relationships between a line connecting a target scene position and the release position and edges as well as corners of the hexagon.

In some embodiments, when the effect shape of the skill is a circle, the above direction information of the skill indicator can be a direction of a diameter of the circle. When the effect shape of the skill is of other shapes, the above direction information of the skill indicator is usually related to the release direction of the skill. For example, when the effect shape is a rectangle, the direction information of the skill indicator is a direction of a centerline along a length direction of the rectangle.

In step S206, the skill indicator is generated and displayed along a direction indicated by the direction information based on an indicator parameter preset for the target skill, by taking the release position as a reference.

The above indicator parameter preset for the target skill refers to a size parameter, a shape parameter, etc. of the skill indicator, which can be determined and preset based on the effect shape and the effect distance of the target skill. In some embodiments, the size parameter of the skill indicator is preset based on the effect shape of the target skill, and different size parameters are preset for different effect shapes. The value of the indicator parameter of the skill indicator can be preset according to the effect distance.

In some embodiments, starting from the release position, the skill indicator is generated and displayed along the direction indicated by the direction information according to the preset size parameter. According to some embodiments, the hexagonal scene unit is used as the minimum measurement unit for the display and calculation of the skill indicator, which is highly aligned with the structure of the virtual scene spliced by hexagons, the indication effectiveness of the skill indicator is improved, and the efficiency of the human-machine interaction in which the user participates is further enhanced.

The above display method for the skill indicator provides a graphical user interface through a terminal device. The virtual scene is displayed in the graphical user interface, and is composed of multiple scene units arranged continuously, with each scene unit being a hexagon. The release position and the effect range of the target skill is determined in response to the triggering operation on the target skill. The release position is a scene unit in the virtual scene, the release position is within the effect range, and the effect range includes multiple scene units. The direction information of the skill indicator of the target skill is determined based on the relative positions of multiple specified scene units in the effect range. The skill indicator is generated and displayed along the direction indicated by the direction information based on the preset indicator parameter of the target skill, by taking the release position as the reference. According to the above methods provided by the present disclosure, the release position and the effect range of the skill are determined based on the hexagonal scene unit, and the direction information is determined based on the specified scene units in the effect range, so that the skill indicator is then generated and displayed based on parameters such as the direction information and the release position. The skill indicator generated by using the above methods is highly aligned with the effect range of the skill, which is conducive to the user quickly determining, based on the skill indicator, whether a hexagonal area is affected. The effect range of the skill can be accurately and clearly indicated, improving the indication effectiveness of the skill indicator and further enhancing the efficiency of the human-machine interaction in which the user participates.

The following embodiments provide specific implementations for determining the release position and the effect range of the target skill.

In response to a drag operation exerted on a skill control for the target skill, the release position of the target skill is determined based on a drag position of the skill control. In the hexagonal coordinate system of the virtual scene, coordinate information of each scene unit in the effect range of the target skill is determined based on an effect range parameter preset for the target skill and the release position. The coordinate information of each scene unit in the effect range of the target skill is determined as the effect range of the target skill.

In some embodiments, the user controls the skill control to move across the hexagonal scene units in the virtual scene by dragging the skill control. The real-time position of the skill control is taken as the release location where the user controls the target character to release the target skill. It should be noted that when the user drags the skill control to move in the virtual scene, and when the skill control is not released, the skill is also not released.

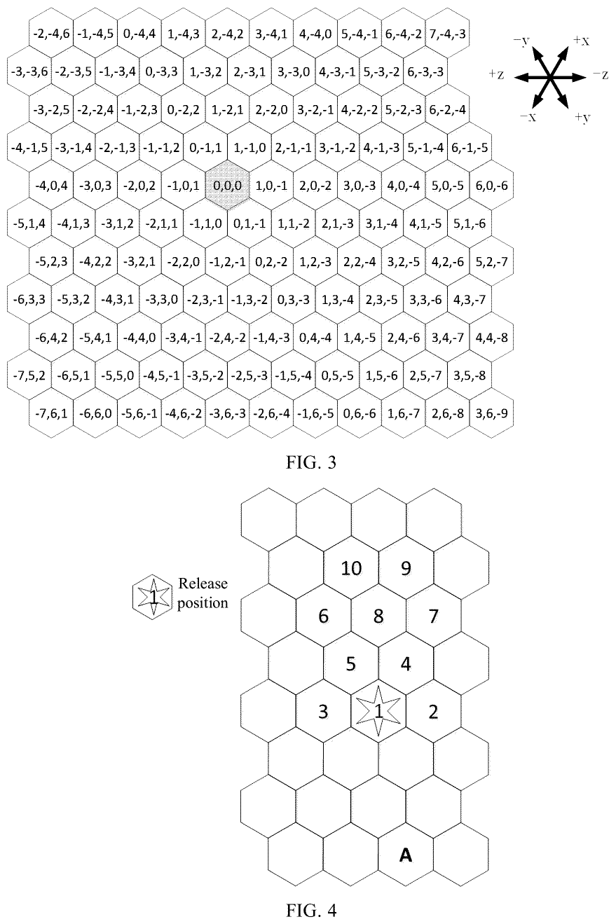

In some embodiments, in the hexagonal coordinate system of the virtual scene, the coordinate information of each scene unit in the effect range of the target skill is determined based on the effect range parameter and the release position preset for the target skill. In some embodiments, the hexagonal coordinate system is an extended coordinate system based on three directions of the hexagonal scene unit in the scene, as shown in FIG. 3. The virtual scene spliced by regular hexagonal scene units is taken as an example. In the virtual scene, a regular hexagonal scene unit is used as a measurement unit, and a regular hexagonal coordinate system is established in advance using a certain regular hexagon (the point filling part in the drawings) as an origin of the coordinate system, to represent the position of each scene unit in the scene. In this way, each objective position in the virtual scene can be represented by corresponding coordinates of the scene unit. The preset effect range parameter refers to relative coordinate parameters of the effect range preset for the target skill, which can be read from the collection of relative coordinates of the effect range based on the parameters such as the effect shape and the effect distance of the target skill.

In some embodiments, the collection of relative coordinates of the effect range is a coordinate collection of the effect range corresponding to each release position set in a hexagonal coordinate system based on skill parameters of different effect shapes and different effect distances. The collection is obtained by calculating relative coordinates by using the release position as the origin. In some embodiments, the coordinate information of each scene unit in the effect range of the skill can be obtained by adding the preset effect range parameters having been read and the coordinates of the release position of the skill located in the hexagonal coordinate system.

In some embodiments, the effect range of the target skill is represented using the above collection of coordinates of each scene unit in the effect range.

In some embodiments, the release position and the effect range of the target skill are accurately positioned using the hexagonal coordinates. Obtaining the effect range coordinates using the preset relative coordinates of the effect range is simple and convenient, which greatly reduces the computational pressure of the computer.

The following embodiments provide specific implementations for determining the direction information of the skill indicator.

The target scene unit that is farthest from the release position in the effect range is obtained, and the direction information of the skill indicator of the target skill is determined based on the relationships between the line connecting the target scene position and the release position and the edges as well as corners of the hexagon.

The target scene unit that is farthest from the release position can be one scene unit or multiple scene units. Taking one target scene unit as an example, the relationships between the line connecting the target scene position and the release position and the edges as well as corners of the hexagon can include various types. In some embodiments, the line connecting the target scene position and the release position may be perpendicular to any edge of the hexagonal scene unit, or may pass through any corner of the hexagonal scene unit, or may neither be perpendicular to any edge nor pass through any corner.

If the line connecting the target scene position and the release position is perpendicular to any edge of the hexagonal scene unit, or passes through any corner of the hexagonal scene unit, the direction of the line connecting the target scene position and the release position can be used as the direction information of the skill indicator. If the line connecting the target scene position and the release position is neither perpendicular to any edge of the hexagonal scene unit nor passes through any corner of the hexagonal scene unit, more than one target scene position needs to be obtained, to enable the line connecting center points of the more than one target scene position and the release position is perpendicular to any edge of the hexagonal scene unit or passes through any corner of the hexagonal scene unit.

For ease of understanding, FIG. 4 is taken as an example. As shown in FIG. 4, A represents the position where the target character is located, and the area where scene units 1-10 are located is the effect range of the target skill which takes the target scene position 1 as the release position and has the effect distance of 3 scene units. In some embodiments, the target scene 10 is farthest from the release position and is determined as the target scene unit. Then the direction information of the skill indicator of the target skill is determined based on the relationships between the line connecting the target scene position and the release position and the edges as well as corners of the hexagon.

In some embodiments, if the line connecting the target scene unit and the release position meets a specified condition, the direction information of the skill indicator of the target skill is determined based on the target scene unit and the release position. In some embodiments, the specified condition includes: the line connecting the target scene unit and the release position is perpendicular to any edge of the hexagon, or passes through any corner of the hexagon. If the line connecting the target scene unit and the release position does not meet the specified condition, the direction information of the skill indicator of the target skill is determined based on the target scene unit, an adjacent scene unit of the target scene unit, and the release position. In some embodiments, a distance between the adjacent scene unit and the release position is not less than distances between scene units other than the target scene unit in the effect range and the release position. It can be understood as the adjacent scene unit is a scene unit having the farthest distance from the release party out of the scene units except for the target scene unit. The distance between the adjacent scene unit and the release unit may be the same or different from the distance between the target scene unit and the release unit.

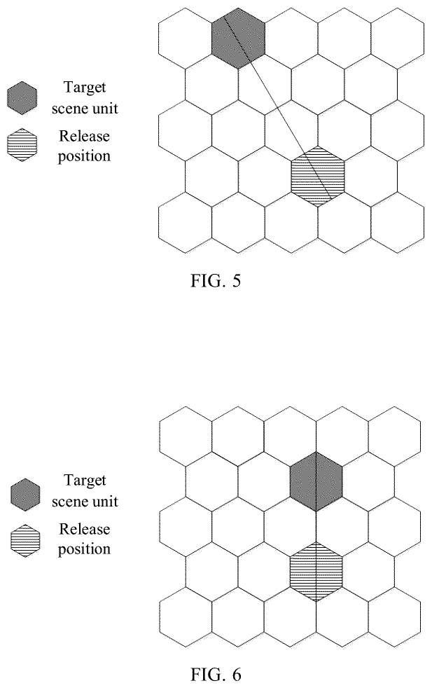

That the line connecting the target scene unit and the release position is perpendicular to any edge of the hexagon can be illustrated by the position relationship of the line segments in FIG. 5. That the line connecting the target scene unit and the release position passes through any corner of the hexagon can be illustrated by the position relationship of the line segments in FIG. 6.

In some embodiments, whether the line connecting the target scene unit and the release position meets the above specified condition can be determined based on position coordinates of the scene unit in the hexagonal coordinate system. In some embodiments, it is assumed that the coordinates of the release position are (a₁, b₁, c₁), and the coordinates of the target scene unit are (a₂, b₂, c₂). The differences in each direction are calculated, i.e. dₐ=a₂−a₁, d_{b}=b₂−b₁, d_{c}=c₂−c₁. If only one of dₐ, d_{b}, and d_{c} is 0, it means that the line connecting the target scene unit and the release position is perpendicular to any edge of the hexagon. If dₐ, d_{b}, and d_{c} are all not 0, but two and only two of them are equal, it means that the line connecting the target scene unit and the release position passes through any corner of the hexagon. If dₐ, d_{b}, and d_{c} are different from each other, it indicates that the line connecting the target scene unit and the release position does not meet the above specified condition.

The direction information of the skill indicator is calculated using different methods based on that the line connecting the target scene unit and the release position meets what specified condition. In some embodiments, taking FIG. 4 as an example, if the line connecting the target scene unit and the release position meets the specified condition, the direction information of the skill indicator of the target skill is determined based on the positions of the hexagonal scene units 1 and 10. If the line connecting the target scene unit and the release position does not meet the specified condition, the hexagonal scene unit 9 is determined as the adjacent scene unit due to that the distance between the positions of scene units 9 and 1 is not less than the distances between scene units other than scene unit 10 in the effect range and scene unit 1. Therefore, the direction information of the skill indicator of the target skill is determined based on the positions of scene units 10, 9, and 1.

The calculation embodiments for determining the direction information of the skill indicator of the target skill will be explained in the following. In some embodiments, if the line connecting the target scene unit and the release position meets the specified condition, the coordinate difference between the target scene unit and the release position is determined as the direction information of the skill indicator of the target skill.

In some embodiments, when the line connecting the target scene unit and the release position meets the specified condition, if the coordinates of the release position in the coordinate collection of the effect range are (a₁, b₁, c₁), and the coordinates of the target scene unit are (a₂, b₂, c₂), then the direction information of the skill indicator of the skill is (a₂-a₁, b₂-b₁, c₂-c₁). It can be understood that the direction of the line connecting the target scene unit and the release position is the direction information of the skill indicator.

In some embodiments, if the line connecting the target scene unit and the release position does not meet the specified condition, the coordinate sum of the target scene unit and the adjacent scene unit is calculated to obtain an intermediate result, and the coordinate difference between the intermediate result and the release position is determined as the direction information of the skill indicator of the target skill.

In some embodiments, when the line connecting the target scene unit and the release position does not meet the specified condition, if the coordinates of the release position are (a₁, b₁, c₁), the coordinates of the target scene unit are (a₂, b₂, c₂), and the coordinates of the adjacent scene unit are (a₃, b₃, c₃), then the direction information of the skill indicator is (a₂+a₃−2a₁, b₂+b₃−2b₁, c₂+c₃−2c₁).

The following embodiments provide specific implementations for displaying the skill indicator.

The size parameter of the skill indicator is determined based on the shape and the effect distance of the effect range of the target skill, and the skill indicator is generated and displayed along the direction indicated by the direction information by taking the release position as a starting point. The display size of the skill indicator matches with the size parameter.

In some embodiments, the shape of the skill indicator is consistent with the effect shape of the target skill, and different size parameters are preset for different shapes of the effect range. For example, the parameters such as the length and the width of the indicator are set for the rectangular effect shape, and the parameter such as the radius is set for the sectorial, the conical, and the circular effect shapes. The parameter value of the skill indicator is preset based on the effect distance of the skill. In some embodiments, taking the rectangle as an example, the maximum effect distance can reach 4 scene units, and the width of the indicator remains 3 edges of the scene unit unchanged. When the effect distance increases from 1 scene unit to 4 scene units, the lengths of the indicator are respectively 1.5, 3, 4.75, and 6.25 edges of the scene unit. In some embodiments, the skill indicator is generated and displayed along the direction indicated by the direction information by taking the release position as the starting point.

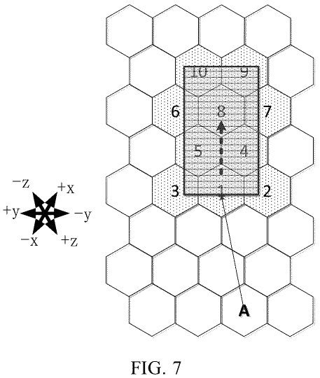

For ease of understanding, FIG. 7 shows a schematic diagram of a rectangular indicator indicating the effect range in some embodiments. As shown in FIG. 7, the rectangle filled with horizontal lines in the schematic diagram is the rectangular indicator generated, the hexagon-spliced area filled with dots is the effect range indicated by the indicator, the direction of the dashed arrow indicates the direction information of the indicator, and the direction of the solid arrow is the release direction of the target skill. As shown in FIG. 7, the skill indicator generated the effect range of the skill have a high intersection over union, that is, the skill indicator highly matches with the effect range. This skill indicator generated can clearly and accurately indicate which hexagonal scene units will be affected by the target skill.

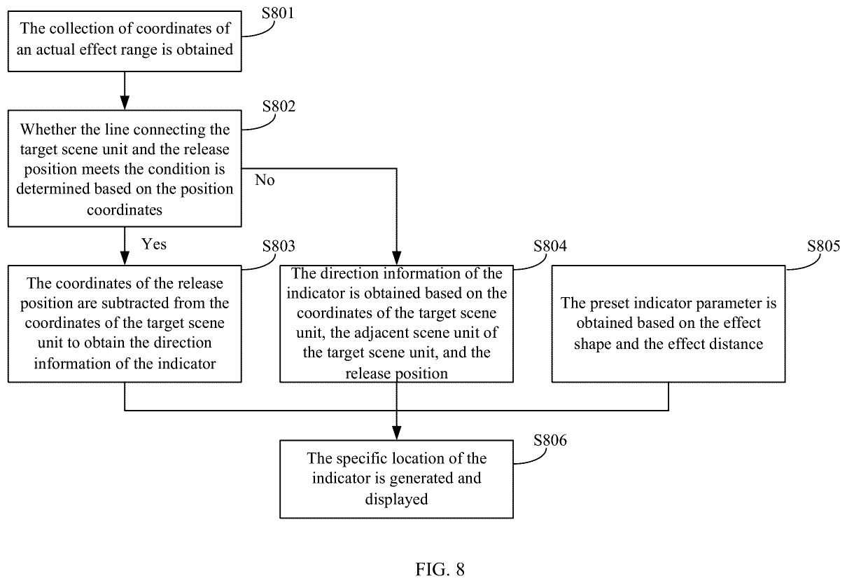

Embodiments of the present disclosure are further provided, and the data processing logic flow in some embodiments is shown in FIG. 8. The display process of the skill indicator will be introduced in detail in the following.

1) The collection of coordinates of an actual effect range is obtained (S801).

As shown in FIG. 7, A represents the position where the target character is located, and the area including scene units 1-10 is the effect range. The effect range is caused by the target character by taking the hexagon 1 at a distance of 3 scene units away as the release position, and releasing the skill at the effect distance of 3 scene units. The hexagonal coordinate system is established by taking the hexagonal scene unit as the minimum measurement unit, and setting the release position as the origin. The coordinates of these 10 scene units constituting the effect range are: 1—(0, 0, 0), 2—(1, −1, 0), 3—(−1, 1, 0), 4—(1, 0, −1), 5—(0, 1, −1), 6—(0, 2, −2), 7—(2, 0, −2), 8—(1, 1, −2), 9—(2, 1, −3), 10—(1, 2, −3). The scene unit 10 is the farthest scene unit from the release position and is determined as the target scene unit. The distance between scene units 9 and 1 is not less than the distance between scene units other than the scene unit 10 in the effect range and the scene unit 1, and the scene unit 9 is determined as the adjacent scene unit.

2) Whether the line connecting the target scene unit and the release position meets the specified condition is determined based on the position coordinates (S802).

The coordinates of the release position within the effect range are (0, 0, 0), and the coordinates of the target scene unit are (1, 2, −3). The differences in each direction are calculated to obtain dₐ=1, d_{b}=2, and d_{c}=−3. The obtained dₐ, d_{b}, and d_{c} are all not 0 and not equal to each other, and thus the line connecting the target scene unit and the release position does not meet the specified condition (No). If it is determined that the line connecting the target scene unit and the release position meets the specified condition (Yes), the direction information of the indicator is obtained by subtracting the coordinates of the release position from the coordinates of the target scene unit (S803).

3) Based on the determination result, the direction information of the indicator is calculated using the coordinates of the target scene unit, the adjacent scene unit, and the release position (S804).

In the effect range collection, the coordinates of the release position are (a₁, b₁, c₁)=(0, 0, 0), the coordinates of the target scene unit are (a₂, b₂, c₂)=(1, 2, −3), and the coordinates of the adjacent scene unit are (a₃, b₃, c₃)=(2, 1, −3). Therefore, the direction vector of the skill indicator is: (a₂+a₃−2a₁, b₂+b₃−2b₁, c₂+c₃−2c₁)=(3, 3, −6).

4) The preset indicator parameter is obtained based on the effect shape and the effect distance (S805).

As mentioned in the above embodiments, when the effect distance is 3 scene units, the rectangular indicator has a length of 4.75 edges of the scene unit and a width of 3 edges of the scene unit.

5) The specific location of the indicator is generated and displayed (S806).

The skill indicator is generated and displayed based on parameters as follows: the coordinates of the release position (0, 0, 0) are taken as a central starting point of the rectangle, the coordinates (3, 3, −6) is taken as the direction, and 4.75 edges and 3 edges of the scene unit are respectively taken as the length and the width of the skill indicator.

It should be noted that while the indicator is displayed, the effect range indicated by the indicator is highlighted.

According to the above display method for the skill indicator, the display range of the skill indicator can be accurately calculated based on the preset size and the calculated direction information of the skill indicator. As a result, the effect range can be accurately and clearly displayed, which improves the indication effectiveness of the skill indicator, further enhancing the efficiency of the human-machine interaction in which the user participates.

It should be noted that although various steps of the method for manufacturing the display module in the present disclosure are described in a specific order in the drawings, this does not require or imply that these steps must be executed in that specific order, or that all the steps shown must be executed to achieve the desired result. Additionally or alternatively, some steps can be omitted, multiple steps can be merged into one step for execution, and/or one step can be split into multiple steps for execution.

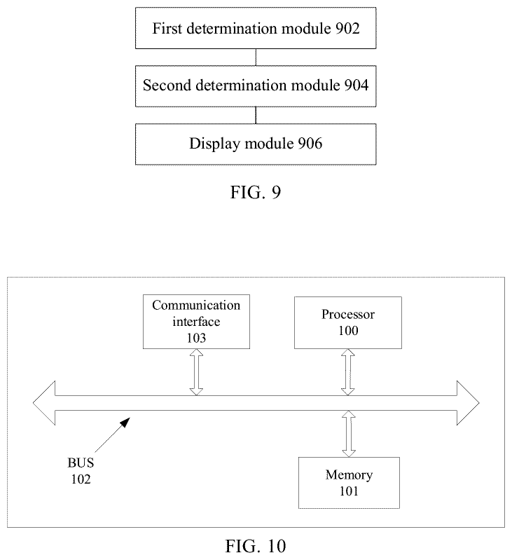

Embodiments of the present disclosure also provide a display apparatus for a skill indicator corresponding to the above method embodiments. As shown in FIG. 9, the schematic diagram of the display apparatus for the skill indicator is illustrated, which provides a graphical user interface through a terminal device. The virtual scenes are displayed in the graphical user interface, each of the virtual scenes is spliced by multiple scene units arranged continuously, and the scene unit is a hexagon. The apparatus includes a first determination module 902, a second determination module 904, and a display module 906.

The first determination module 902 is configured to determine, in response to a triggering operation on a target skill, a release position and an effect range of the target skill. The release position is a scene unit in a virtual scene, the release position is within the effect range, and the effect range includes multiple scene units.

The second determination module 904 is configured to determine, based on relative positions of multiple specified scene units in the effect range, direction information of the skill indicator of the target skill.

The display module 906 is configured to generate and display the skill indicator along a direction indicated by the direction information based on an indicator parameter preset for the target skill, by taking the release position as a reference.

The above display apparatus for the skill indicator provides a graphical user interface through a terminal device. The virtual scene is displayed in the graphical user interface, and is composed of multiple scene units arranged continuously, with each scene unit being a hexagon. The release position and the effect range of the target skill is determined in response to the triggering operation on the target skill. The release position is a scene unit in the virtual scene, the release position is within the effect range, and the effect range includes multiple scene units. The direction information of the skill indicator of the target skill is determined based on the relative positions of multiple specified scene units in the effect range. The skill indicator is generated and displayed along the direction indicated by the direction information based on the indicator parameter preset for the target skill, by taking the release position as the reference. According to the above methods provided by the present disclosure, the release position and the effect range of the skill are determined based on the hexagonal scene unit, and the direction information is determined based on the specified scene units in the effect range, so that the skill indicator is then generated and displayed based on parameters such as the direction information and the release position. In the apparatus, the hexagonal scene unit is used as the minimum measurement unit to accurately generate and display the skill indicator, which can display the effect range accurately and clearly, improving the indication effectiveness of the skill indicator and further enhancing the efficiency of the human-machine interaction in which the user participates.

In some embodiments, the first determination module 902 is further configured to determine, in response to a drag operation exerted on a skill control for the target skill, the release position of the target skill based on a drag position of the skill control; determine, in a hexagonal coordinate system of the virtual scene, coordinate information of each scene unit in the effect range of the target skill, based on an effect range parameter preset for the target skill and the release position; and determine the coordinate information of each scene unit in the effect range of the target skill as the effect range of the target skill.

In some embodiments, the second determination module 904 is further configured to obtain a target scene unit that is farthest from the release position in the effect range; and determine the direction information of the skill indicator of the target skill based on relationships between a line connecting the target scene unit and the release position and edges as well as corners of the hexagon.

In some embodiments, the second determination module 904 is further configured to determine, in response to the line connecting the target scene unit and the release position meeting a specified condition, the direction information of the skill indicator of the target skill based on the target scene unit and the release position, wherein the specified condition includes the line connecting the target scene unit and the release position being perpendicular to any edge of the hexagon, or the line connecting the target scene unit and the release position passing through any corner of the hexagon; and determine, in response to the line connecting the target scene unit and the release position not meeting the specified condition, the direction information of the skill indicator of the target skill based on the target scene unit, an adjacent scene unit of the target scene unit, and the release position, wherein a distance between the adjacent scene unit and the release position is not less than distances between scene units other than the target scene unit in the effect range and the release position.

In some embodiments, the second determination module 904 is further configured to determine, in response to the line connecting the target scene unit and the release position meeting the specified condition, coordinate difference between the target scene unit and the release position as the direction information of the skill indicator of the target skill.

In some embodiments, the second determination module 904 is further configured to obtain, in response to the line connecting the target scene unit and the release position not meeting the specified condition, an intermediate result by calculating a coordinate sum of the target scene unit and the adjacent scene unit; and determine coordinate difference between the intermediate result and the release position as the direction information of the skill indicator of the target skill.

In some embodiments, the above display module 906 is further configured to determine a size parameter of the skill indicator based on a shape and an effect distance of the effect range of the target skill; and generate and display the skill indicator along the direction indicated by the direction information, by taking the release position as the reference, wherein a display size of the skill indicator matches with the size parameter.

The specific implementation details of each module in the above display apparatus for the skill indicator have been described in the corresponding display methods for the skill indicator, and will not be repeated here.

Embodiments of the present disclosure also provide an electronic device including a processor and a memory. The memory stores machine-executable instructions that can be executed by a processor, and the processor is configured to execute the machine-executable instructions to implement the display method for the skill indicator described in the above. The electronic device can be a server or a terminal device.

As shown in FIG. 10, the electronic device includes a processor 100 and a memory 101. The memory 101 stores machine-executable instructions that can be executed by the processor 100. The processor 100 is configured to execute the machine-executable instructions to implement the display method for the skill indicator mentioned in the above.

In some embodiments, the electronic device shown in FIG. 10 further includes a bus 102 and a communication interface 103. The processor 100, the communication interface 103, and the memory 101 are connected through the bus 102.

In some embodiments, the memory 101 may include high-speed random access memory (RAM), and may also include non-volatile memory, such as at least one disk memory. The communication connection between the system network element and at least one other network element is realized through at least one communication interface 103 (which can be wired or wireless), where Internet, WAN, LAN, MAN, etc., can be used. A bus 102 can be ISA (Industry Standard Architecture) bus, PCI (Peripheral Component Interconnect) bus or EISA (Extended Industry Standard Architecture) bus. The bus 102 can be divided into address bus, data bus, control bus, etc. For ease of representation, only one bidirectional arrow is used in FIG. 10, but it does not mean that there is only one bus or one type of bus.

The processor 100 may be an integrated circuit chip with signal processing capability. In the implementation process, each step of the above method can be completed by the integrated logic circuit of hardware or instructions in the form of software in the processor 100. The above processor 100 can be a general-purpose processor, including a central Processing unit (CPU), a network Processor (NP), etc. It can also be Digital Signal Processor (DSP for short), Application Specific Integrated Circuit (ASIC for short), Field programmable Gate Array (FPGA for short) or other Programmable logic devices, discrete gates or transistor logic devices, discrete hardware components. A general-purpose processor may be a microprocessor or the processor may also be any conventional processor or the like. The steps of the method disclosed in combination with the embodiments of the present disclosure can be directly embodied in the completion of the hardware decoding processor or the combination of hardware and software modules in the decoding processor. Software modules can be located in RAM, flash memory, read-only memory, programmable read-only memory or electrically erasable programmable memory, registers and other mature storage media in the field. The storage medium is located in the memory 101, and the processor 100 reads the information in the memory 101 and completes the steps of the display method for the skill indicator in combination with its hardware. The display method for the skill indicator includes: providing a graphical user interface through a terminal device, wherein a virtual scene is displayed in the graphical user interface, the virtual scene is composed of multiple scene units arranged continuously, and the scene unit is a hexagon; determining, in response to a triggering operation on a target skill, a release position and an effect range of the target skill, wherein the release position is a scene unit in the virtual scene, the release position is located in the effect range, and the effect range includes multiple scene units; determining direction information of the skill indicator of the target skill based on relative positions of multiple specified scene units in the effect range; and generating and displaying the skill indicator along a direction indicated by the direction information, based on an indicator parameter preset for the target skill, by taking the release position as a reference.

In some embodiments, the step of determining, in response to the triggering operation on the target skill, the release position and the effect range of the target skill includes: determining, in response to a drag operation exerted on a skill control for the target skill, the release position of the target skill based on a drag position of the skill control; determining, in a hexagonal coordinate system of the virtual scene, coordinate information of each scene unit in the effect range of the target skill, based on an effect range parameter preset for the target skill and the release position; and determining the coordinate information of each scene unit in the effect range of the target skill as the effect range of the target skill.

In some embodiments, the step of determining the direction information of the skill indicator of the target skill based on the relative positions of the multiple specified scene units in the effect range includes: obtaining a target scene unit that is farthest from the release position in the effect range; and determining the direction information of the skill indicator of the target skill based on relationships between a line connecting the target scene unit and the release position and edges as well as corners of the hexagon.

In some embodiments, the step of determining the direction information of the skill indicator of the target skill based on the relationships between the line connecting the target scene unit and the release position and the edges as well as the corners of the hexagon, includes: determining, in response to the line connecting the target scene unit and the release position meeting a specified condition, the direction information of the skill indicator of the target skill based on the target scene unit and the release position, wherein the specified condition includes the line connecting the target scene unit and the release position being perpendicular to any edge of the hexagon, or the line connecting the target scene unit and the release position passing through any corner of the hexagon; and determining, in response to the line connecting the target scene unit and the release position not meeting the specified condition, the direction information of the skill indicator of the target skill based on the target scene unit, an adjacent scene unit of the target scene unit, and the release position, wherein a distance between the adjacent scene unit and the release position is not less than distances between scene units other than the target scene unit in the effect range and the release position.

In some embodiments, the step of determining, in response to the line connecting the target scene unit and the release position meeting the specified condition, the direction information of the skill indicator of the target skill based on the target scene unit and the release position, includes: determining, in response to the line connecting the target scene unit and the release position meeting the specified condition, coordinate difference between the target scene unit and the release position as the direction information of the skill indicator of the target skill.

In some embodiments, the step of determining, in response to the line connecting the target scene unit and the release position not meeting the specified condition, the direction information of the skill indicator of the target skill based on the target scene unit, the adjacent scene unit of the target scene unit, and the release position, includes: obtaining, in response to the line connecting the target scene unit and the release position not meeting the specified condition, an intermediate result by calculating a coordinate sum of the target scene unit and the adjacent scene unit; and determining coordinate difference between the intermediate result and the release position as the direction information of the skill indicator of the target skill.

In some embodiments, the step of generating and displaying the skill indicator along the direction indicated by the direction information, based on the indicator parameter preset for the target skill, by taking the release position as the reference, includes: determining a size parameter of the skill indicator based on a shape and an effect distance of the effect range of the target skill; and generating and displaying the skill indicator along the direction indicated by the direction information, by taking the release position as the reference, wherein a display size of the skill indicator matches with the size parameter.

According to the above embodiments, the release position and the effect range of the skill are determined based on the hexagonal scene unit, and the direction information is determined based on the specified scene units in the effect range, so that the skill indicator is then generated and displayed based on parameters such as the direction information and the release position. The skill indicator generated by using the above methods is highly aligned with the effect range of the skill, which is conducive to the user quickly determining, based on the skill indicator, whether a hexagonal area is affected. The effect range of the skill can be accurately and clearly indicated, improving the indication effectiveness of the skill indicator and further enhancing the efficiency of the human-machine interaction in which the user participates.

Embodiments of the present disclosure also provide a machine-readable storage medium that stores machine-executable instructions. When the machine-executable instructions are called and executed by a processor, the machine-executable instructions cause the processor to implement the display method for the skill indicator. The display method for the skill indicator includes: providing a graphical user interface through a terminal device, wherein a virtual scene is displayed in the graphical user interface, the virtual scene is composed of multiple scene units arranged continuously, and the scene unit is a hexagon; determining, in response to a triggering operation on a target skill, a release position and an effect range of the target skill, wherein the release position is a scene unit in the virtual scene, the release position is located in the effect range, and the effect range includes multiple scene units; determining direction information of the skill indicator of the target skill based on relative positions of multiple specified scene units in the effect range; and generating and displaying the skill indicator along a direction indicated by the direction information, based on an indicator parameter preset for the target skill, by taking the release position as a reference.

In some embodiments, the step of determining, in response to the triggering operation on the target skill, the release position and the effect range of the target skill includes: determining, in response to a drag operation exerted on a skill control for the target skill, the release position of the target skill based on a drag position of the skill control; determining, in a hexagonal coordinate system of the virtual scene, coordinate information of each scene unit in the effect range of the target skill, based on an effect range parameter preset for the target skill and the release position; and determining the coordinate information of each scene unit in the effect range of the target skill as the effect range of the target skill.

In some embodiments, the step of determining the direction information of the skill indicator of the target skill based on the relative positions of the multiple specified scene units in the effect range includes: obtaining a target scene unit that is farthest from the release position in the effect range; and determining the direction information of the skill indicator of the target skill based on relationships between a line connecting the target scene unit and the release position and edges as well as corners of the hexagon.

In some embodiments, the step of determining the direction information of the skill indicator of the target skill based on the relationships between the line connecting the target scene unit and the release position and the edges as well as the corners of the hexagon, includes: determining, in response to the line connecting the target scene unit and the release position meeting a specified condition, the direction information of the skill indicator of the target skill based on the target scene unit and the release position, wherein the specified condition includes the line connecting the target scene unit and the release position being perpendicular to any edge of the hexagon, or the line connecting the target scene unit and the release position passing through any corner of the hexagon; and determining, in response to the line connecting the target scene unit and the release position not meeting the specified condition, the direction information of the skill indicator of the target skill based on the target scene unit, an adjacent scene unit of the target scene unit, and the release position, wherein a distance between the adjacent scene unit and the release position is not less than distances between scene units other than the target scene unit in the effect range and the release position.

In some embodiments, the step of determining, in response to the line connecting the target scene unit and the release position meeting the specified condition, the direction information of the skill indicator of the target skill based on the target scene unit and the release position, includes: determining, in response to the line connecting the target scene unit and the release position meeting the specified condition, coordinate difference between the target scene unit and the release position as the direction information of the skill indicator of the target skill.

In some embodiments, the step of determining, in response to the line connecting the target scene unit and the release position not meeting the specified condition, the direction information of the skill indicator of the target skill based on the target scene unit, the adjacent scene unit of the target scene unit, and the release position, includes: obtaining, in response to the line connecting the target scene unit and the release position not meeting the specified condition, an intermediate result by calculating a coordinate sum of the target scene unit and the adjacent scene unit; and determining coordinate difference between the intermediate result and the release position as the direction information of the skill indicator of the target skill.

In some embodiments, the step of generating and displaying the skill indicator along the direction indicated by the direction information, based on the indicator parameter preset for the target skill, by taking the release position as the reference, includes: determining a size parameter of the skill indicator based on a shape and an effect distance of the effect range of the target skill; and generating and displaying the skill indicator along the direction indicated by the direction information, by taking the release position as the reference, wherein a display size of the skill indicator matches with the size parameter.

According to the above embodiments, the release position and the effect range of the skill are determined based on the hexagonal scene unit, and the direction information is determined based on the specified scene units in the effect range, so that the skill indicator is then generated and displayed based on parameters such as the direction information and the release position. The skill indicator generated by using the above methods is highly aligned with the effect range of the skill, which is conducive to the user quickly determining, based on the skill indicator, whether a hexagonal area is affected. The effect range of the skill can be accurately and clearly indicated, improving the indication effectiveness of the skill indicator and further enhancing the efficiency of the human-machine interaction in which the user participates.

The computer program product of the display method for the skill indicator, the display apparatus for the skill indicator, and the system provided in embodiments of the present disclosure includes a computer-readable storage medium that stores program code. The instructions included in the program code can be used to execute the method described in the preceding method embodiment. For specific implementation, refer to the method embodiment, and will not be repeated here.

Those skilled in the art can clearly understand that, for the convenience and simplicity of description, the specific working process of the above described systems and devices can refer to the corresponding process in the above method embodiments, and will not be repeated here.

In addition, in the description of the embodiments of the present disclosure, unless otherwise specified and defined, the terms “installation”, “connection” and “connection” should be understood broadly, for example, they can be fixed connection, removable connection, or integrated connection; It can be mechanical connection or electrical connection; It can be directly connected, or indirectly connected through intermediate media. It can be the connection between two components. For those skilled in the art, the specific meaning of the above terms in this disclosure can be understood in specific cases.

If the functions are realized in the form of software functional units and sold or used as independent products, they can be stored in a computer readable storage medium. Based on this understanding, the technical solution of the present disclosure can be embodied in the form of a software product, which is stored in a storage medium, a number of instructions are included to enable a computer device (which may be a personal computer, a server, or a network device, etc.) to perform all or part of the steps of the method described in various embodiments of the present disclosure. The aforementioned storage media include: USB flash disk, mobile hard disk, read only memory (ROM), random access memory (RAM), magnetic disc or optical disc and other media that can store program codes.

In the description of the present disclosure, it should be noted that the terms “center”, “top”, “bottom”, “left”, “right”, “vertical”, “horizontal”, “inside”, “outside”, etc. indicate the orientation or position relationship based on the orientation or position relationship shown in the drawings, only for the convenience of describing the present disclosure and simplifying the description, rather than indicating or implying that the device or element referred to must have a specific orientation It is constructed and operated in a specific orientation, and therefore cannot be understood as a limitation of the present disclosure. In addition, the terms “first”, “second” and “third” are only used for describing purposes and cannot be understood as indicating or implying relative importance.

Finally, it should be noted that the above embodiments are only specific embodiments of the disclosure to illustrate the technical solutions of the disclosure, rather than limit them. The scope of protection of the disclosure is not limited to this. Although the disclosure has been described in detail with reference to the aforementioned embodiments, those skilled in the art should understand that: any person skilled in the technical field is within the scope of the disclosure, It can still modify or easily think of changes to the technical solutions recorded in the aforementioned embodiments, or equivalently replace some of the technical features; However, these modifications, changes or substitutions do not make the nature of the corresponding technical solutions deviate from the spirit and scope of the technical solutions of the embodiments of the present disclosure, and should be covered in the scope of protection of the present disclosure. Therefore, the protection scope of the disclosure shall be subject to the protection scope of the claims.

1. A display method for a skill indicator, performed by a terminal device, comprising:
determining, in response to a triggering operation on a target skill, a release position and an effect range of the target skill, wherein the release position is a scene unit in a virtual scene displayed in a graphical user interface, the virtual scene comprises a plurality of scene units, the plurality of scene units are arranged continuously, and the scene unit is in a shape of a hexagon, and wherein the release position is located in the effect range, and the effect range comprises some of the plurality of scene units;
determining direction information of the skill indicator of the target skill based on relative positions of multiple specified scene units in the effect range; and
generating and displaying the skill indicator along a direction indicated by the direction information, based on an indicator parameter preset for the target skill, by taking the release position as a reference.

2. The method according to claim 1, wherein determining, in response to the triggering operation on the target skill, the release position and the effect range of the target skill, comprises:
determining, in response to a drag operation exerted on a skill control for the target skill, the release position of the target skill based on a drag position of the skill control;
determining, in a hexagonal coordinate system of the virtual scene, coordinate information of each scene unit in the effect range of the target skill, based on an effect range parameter preset for the target skill and the release position; and
determining the coordinate information of each scene unit in the effect range of the target skill as the effect range of the target skill.

3. The method according to claim 1, wherein determining the direction information of the skill indicator of the target skill based on the relative positions of the multiple specified scene units in the effect range, comprises:
obtaining a target scene unit that is farthest from the release position in the effect range; and
determining the direction information of the skill indicator of the target skill based on relationships between a line connecting the target scene unit and the release position and edges as well as corners of the hexagon.

4. The method according to claim 3, wherein determining the direction information of the skill indicator of the target skill comprises:
determining, in response to the line connecting the target scene unit and the release position meeting a specified condition, the direction information of the skill indicator of the target skill based on the target scene unit and the release position, wherein the specified condition comprises the line connecting the target scene unit and the release position being perpendicular to any edge of the hexagon, or the line connecting the target scene unit and the release position passing through any corner of the hexagon; and
determining, in response to the line connecting the target scene unit and the release position not meeting the specified condition, the direction information of the skill indicator of the target skill based on the target scene unit, an adjacent scene unit of the target scene unit, and the release position, wherein a distance between the adjacent scene unit and the release position is not less than distances between scene units other than the target scene unit in the effect range and the release position.

5. The method according to claim 4, wherein determining the direction information of the skill indicator of the target skill based on the target scene unit and the release position, comprises:
determining coordinate difference between the target scene unit and the release position as the direction information of the skill indicator of the target skill.

6. The method according to claim 4, wherein determining the direction information of the skill indicator of the target skill based on the target scene unit, the adjacent scene unit of the target scene unit, and the release position, comprises:
obtaining an intermediate result by calculating a coordinate sum of the target scene unit and the adjacent scene unit; and
determining coordinate difference between the intermediate result and the release position as the direction information of the skill indicator of the target skill.

7. The method according to claim 1, wherein generating and displaying the skill indicator along the direction indicated by the direction information, based on the indicator parameter preset for the target skill, by taking the release position as the reference, comprises:
determining a size parameter of the skill indicator based on a shape and an effect distance of the effect range of the target skill; and
generating and displaying the skill indicator along the direction indicated by the direction information, by taking the release position as the reference, wherein a display size of the skill indicator matches with the size parameter.

8. (canceled)

9. An electronic device comprising a processor and a memory, wherein the memory stores computer-executable instructions that can be executed by a processor, and when the processor executes the computer-executable instructions, the processor is configured to:
determine, in response to a triggering operation on a target skill, a release position and an effect range of the target skill, wherein the release position is a scene unit in a virtual scene displayed in a graphical user interface, the virtual scene comprises a plurality of scene units, the plurality of scene units are arranged continuously, and the scene unit is in a shape of a hexagon, and wherein the release position is located in the effect range, and the effect range comprises some of the plurality of scene units;
determine direction information of the skill indicator of the target skill based on relative positions of multiple specified scene units in the effect range; and
generate and display the skill indicator along a direction indicated by the direction information, based on an indicator parameter preset for the target skill, by taking the release position as a reference.

10. A non-transitory computer-executable storage medium having computer-executable instructions stored thereon, which when called and executed by a processor, cause the processor to implement the display method for the skill indicator according to claim 1.

11. The method according to claim 4, wherein determining whether the line connecting the target scene unit and the release position meets the specified condition, comprises:
calculating differences between coordinates of the target scene unit and coordinates of the release position in each direction;
in response to only one of the differences being 0, determining that the line connecting the target scene unit and the release position is perpendicular to any edge of the hexagon;
in response to none of the differences being 0 and two of the differences being equal, determining that the line connecting the target scene unit and the release position passes through any corner of the hexagon; and
in response to the differences being different from each other, determining that the line connecting the target scene unit and the release position is not perpendicular to an edge of the hexagon, and does not pass through a corner of the hexagon.

12. The method according to claim 7, wherein the effect distance comprises one scene unit, two scene units, three scene units or four scene units.

13. The electronic device according to claim 9, wherein the processor is further configured to:
determine, in response to a drag operation exerted on a skill control for the target skill, the release position of the target skill based on a drag position of the skill control;
determine, in a hexagonal coordinate system of the virtual scene, coordinate information of each scene unit in the effect range of the target skill, based on an effect range parameter preset for the target skill and the release position; and
determine the coordinate information of each scene unit in the effect range of the target skill as the effect range of the target skill.

14. The electronic device according to claim 9, wherein the processor is further configured to:
obtain a target scene unit that is farthest from the release position in the effect range; and
determine the direction information of the skill indicator of the target skill based on relationships between a line connecting the target scene unit and the release position and edges as well as corners of the hexagon.

15. The electronic device according to claim 14, wherein the processor is further configured to:
determine, in response to the line connecting the target scene unit and the release position meeting a specified condition, the direction information of the skill indicator of the target skill based on the target scene unit and the release position, wherein the specified condition comprises the line connecting the target scene unit and the release position being perpendicular to any edge of the hexagon, or the line connecting the target scene unit and the release position passing through any corner of the hexagon; and
determine, in response to the line connecting the target scene unit and the release position not meeting the specified condition, the direction information of the skill indicator of the target skill based on the target scene unit, an adjacent scene unit of the target scene unit, and the release position, wherein a distance between the adjacent scene unit and the release position is not less than distances between scene units other than the target scene unit in the effect range and the release position.

16. The electronic device according to claim 15, wherein the processor is further configured to:
determine coordinate difference between the target scene unit and the release position as the direction information of the skill indicator of the target skill.

17. The electronic device according to claim 15, wherein the processor is further configured to:
obtain an intermediate result by calculating a coordinate sum of the target scene unit and the adjacent scene unit; and
determine coordinate difference between the intermediate result and the release position as the direction information of the skill indicator of the target skill.

18. The electronic device according to claim 9, wherein the processor is further configured to:
determine a size parameter of the skill indicator based on a shape and an effect distance of the effect range of the target skill; and
generate and display the skill indicator along the direction indicated by the direction information, by taking the release position as the reference, wherein a display size of the skill indicator matches with the size parameter.

19. The electronic device according to claim 15, wherein the processor is further configured to:
calculate differences between coordinates of the target scene unit and coordinates of the release position in each direction;
in response to only one of the differences being 0, determine that the line connecting the target scene unit and the release position is perpendicular to any edge of the hexagon;
in response to none of the differences being 0 and two of the differences being equal, determine that the line connecting the target scene unit and the release position passes through any corner of the hexagon; and
in response to the differences being different from each other, determine that the line connecting the target scene unit and the release position is not perpendicular to an edge of the hexagon, and does not pass through a corner of the hexagon.

20. The electronic device according to claim 18, wherein the effect distance comprises one scene unit, two scene units, three scene units or four scene units.
